(19) United States
(12) Patent Application Publication
(10) Pub. No.: US 2014/0122466 A1
(43) Pub. Date: May 1, 2014

(54) APPARATUS AND METHOD FOR DATA SEARCH

(71) Applicant: QUANTA COMPUTER INC., Kuei Shan Hsiang (TW)

(72) Inventors: Tien-Chin Fang, Kuei Shan Hsiang (TW); Ching-Yu Tsai, Kuei Shan Hsiang (TW); Chih-Ling Liu, Kuei Shan Hsiang (TW); Ming-Jen Chen, Kuei Shan Hsiang (TW); Ching-Wen Lin, Kuei Shan Hsiang (TW); Chia-Hung Lin, Kuei Shan Hsiang (TW); Chen-Chung Lee, Kuei Shan Hsiang (TW); Chun-He Lin, Kuei Shan Hsiang (TW)

(73) Assignee: Quanta Computer Inc., Kuei Shan Hsiang (TW)

(21) Appl. No.: 13/835,455

(22) Filed: Mar. 15, 2013

(30) Foreign Application Priority Data
Oct. 29, 2012 (TW) 101139867

(51) Int. Cl. G06F 17/30

(52) U.S. Cl. CPC G06F 17/30991
USPC 707/723

(57) ABSTRACT

An data search apparatus includes: a storage unit, storing a plurality of data; an input unit, inputting a data name, selecting a plurality of preference sets, and inputting a grading set by a user; a process unit, receiving the data name for searching for a plurality of candidate data from the data stored in a storage unit and generating a ranking result.

### CROSS REFERENCE TO RELATED APPLICATIONS

This Application claims priority of Taiwan Patent Application No.101139867, filed on Oct. 29, 2012, the entirety of which is incorporated by reference herein.

### BACKGROUND OF THE INVENTION

1. Field of the Invention

The disclosure is related to data search, and, more particularly, the application of preferential conditions of different types of users to generate a ranking result for data search.

2. Description of the Related Art

General search functions do not provide preferential conditions for different types of users. Therefore, search results do not satisfy every user, and users are sometimes unable to search for desired information.

### BRIEF SUMMARY OF THE INVENTION

An embodiment of the invention provides an data search apparatus, comprising: a storage unit, storing a plurality of data; an input unit, inputting a data name, selecting a plurality of preference sets and inputting a grading set, by a user; a process unit, receiving the data name for searching for a plurality of candidate data from the data stored in a storage unit and generating a ranking result according to the candidate data, the preference sets and the grading set; and a display unit, displaying the ranking result.

An embodiment of the invention provides a method for data search, comprising: obtaining a data name; searching a plurality of candidate data from a plurality of data stored in a storage unit by a process unit according to the data name; obtaining preference sets and a grading set; generating a ranking result according to the candidate data, the preference sets and the grading set; and displaying the ranking result by a display unit.

### BRIEF DESCRIPTION OF THE DRAWINGS

The invention will become more fully understood by referring to the following detailed description with reference to the accompanying drawings, wherein:

FIG. 1 is a schematic diagram illustrating the data search apparatus 100 according to an embodiment of the invention;

FIG. 2 is a schematic diagram illustrating the process unit 130 according to an embodiment of the invention;

FIG. 3 is a flowchart of a data search method according to an embodiment of the invention;

FIG. 4 is a flowchart of the step S340 of FIG. 3 according to an embodiment of the invention.

### DETAILED DESCRIPTION OF THE INVENTION

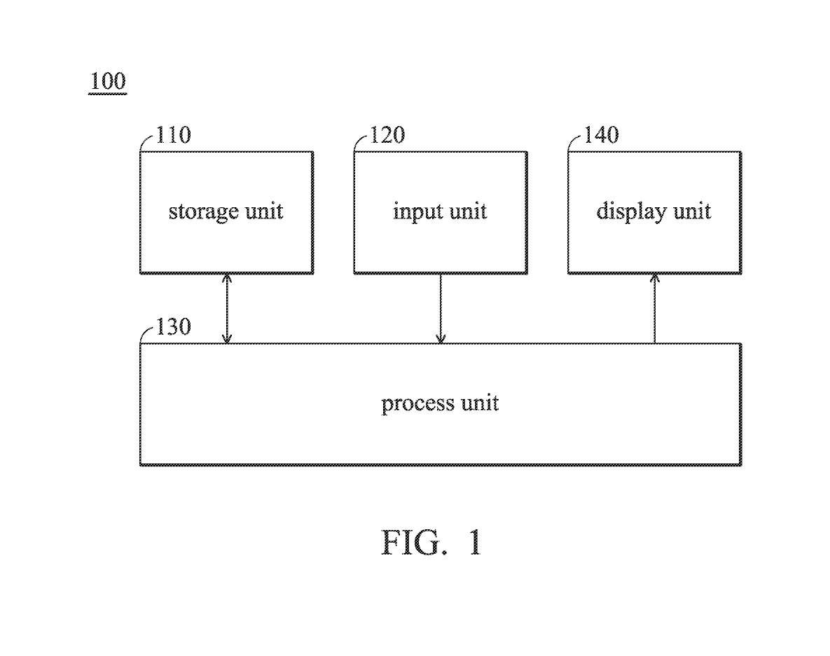

FIG. 1 is a schematic diagram illustrating the data search apparatus 100 according to an embodiment of the invention. In the FIG. 1, the data search apparatus 100 comprises a storage unit 110, an input unit 120, a process unit 130 and a display unit 140.

In an embodiment of the invention, a storage unit 110 is configured to store a plurality of data. For example, the plurality of data may comprise the information corresponding to the different types of devices, such as a device name, device price, and device weight. The input unit 120 is configured to input a data name, search preference sets and a grading set, by a user, wherein the data name is the name of a device, and the preference sets comprise the price, weight, rank, examine times, the result of a quality test, and Restriction of Hazardous Substances (RoHS) of the device. The factors of the preference sets can be provided to different types of users, such as research and development (RD) personal, quality assurance engineers and procurement engineers, and the different types of users can select the factors of the preference sets according to their preference. In addition, the user can set a grading set according to the selected factors after the user has selected the factors of the preference sets. For example, if a user selects the price, examine times and Restriction of Hazardous Substances (RoHS), the user may set a grading set for the three factors and the user can set the factors as different grades according to pre-set grade intervals (such as: 1-9 point), for example, the price is set as 9 points, the examine times is set as 6 points, and the Restriction of Hazardous Substances (RoHS) is set as 3 points. A preference matrix is generated from the grading set. The detailed description of the preference matrix will introduce below.

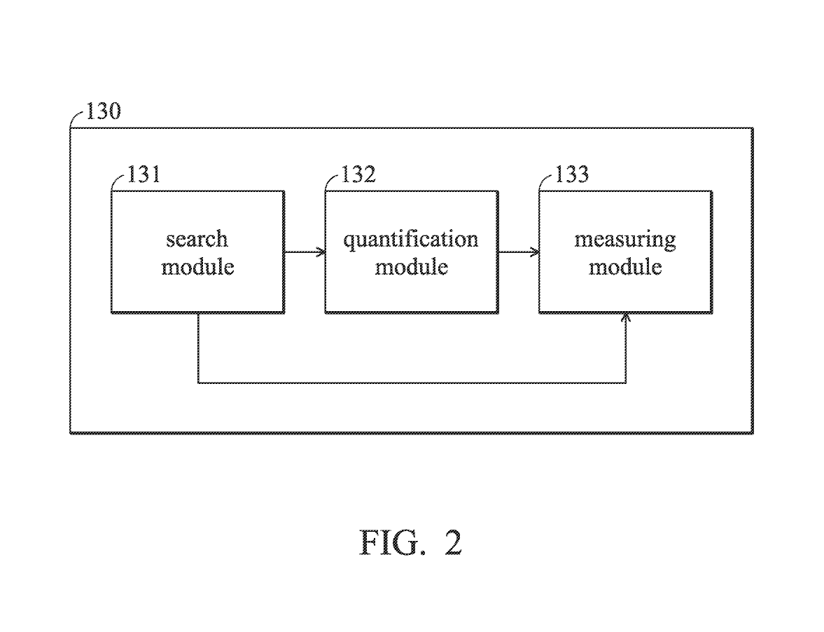

FIG. 2 is a schematic diagram illustrating the process unit 130 according to an embodiment of the invention. In an embodiment of the invention, the process unit 130 comprises a search module 131, quantification module 132 and a measuring module 133. The search module 131 is configured to search the plurality of candidate data from the storage unit 110 according to the data name which the user inputted. In an embodiment of the invention, the candidate data searches by the search module 131 can also be filtered by a sorting mechanism in advance. For example, a user may need a device with a lower price, therefore, the candidate data with a price higher than a minimum can be filtered in advance, or the user may need the Restriction of Hazardous Substances (RoHS) to be a green light, therefore, the candidate data with the Restriction of Hazardous Substances (RoHS) of yellow or red may be filtered in advance. Also, the limitation of the device in specification list which the customer indicates also can also be used to sort the candidate data in advance. The examples described above are only for illustration and does not limit the invention. Those who are skilled in this technology can still use other appropriate sorting mechanisms to select the candidate data.

A user will select desired preference sets, after the search module 131 searches the candidate data. Then the quantification module 132 will quantify parts of the selected preference sets which have not been quantized. For example, the Restriction of Hazardous Substances (RoHS) must be a green, yellow or red light for determining different hazardous substances, therefore, the quantification module 132 will quantify the options of the Restriction of Hazardous Substances (RoHS), for example, the green light is set as 3, the yellow light is set as 2, and the red light is set as 1. Finally, the measuring module 133 generates a ranking result corresponding to the candidate data according to the candidate data, the quantified preference sets and the grading set. The user may select a desired device according to the ranking result.

The detailed process of the measuring module 133 will described below. In an embodiment of the invention, the measuring module 133 may generate a preference matrix according to the selected preference sets and the values of the grading set, and the measuring module 133 performs a weighting process for the preference matrix for generating a first weighted result. Then, the measuring module 133 may generate a data factor matrix according to a plurality of information corresponding to the preference sets in the candidate data, wherein the measuring module 133 programs a weighting process for the data factor matrix for generating a second weighted result. Then, the measuring module 133 will generate the ranking result corresponding to the candidate data according the first weighed result and the second weighted result.

In an embodiment of the invention, a display unit 140 may display the ranking result corresponding to the candidate data, and the user may select a desired device according to the ranking result. In an embodiment of the invention, the process unit 130 may transmit the ranking result to the storage unit 110 and update the ranked information corresponding to the candidate date in the storage unit 110. In an embodiment of the invention, the preference sets can comprise preference ranks, and the preference ranks are different for different types of users, for example, research and development (RD) personal may have their own preference rank, quality assurance engineers may have their own preference rank and procurement engineers may have their own preference rank. Therefore, the user can also select the preference rank as an option of the selected preference sets when the user selects the preference sets, and the results of the preference rank could be updated according to the ranking result corresponding to the different types of users. In an embodiment of the invention, the preference rank can also apply to different customers, and the user can select the preference rank as an option of the selected preference sets when the user selects the preference set, wherein the preference rank corresponds to a customer of the user.

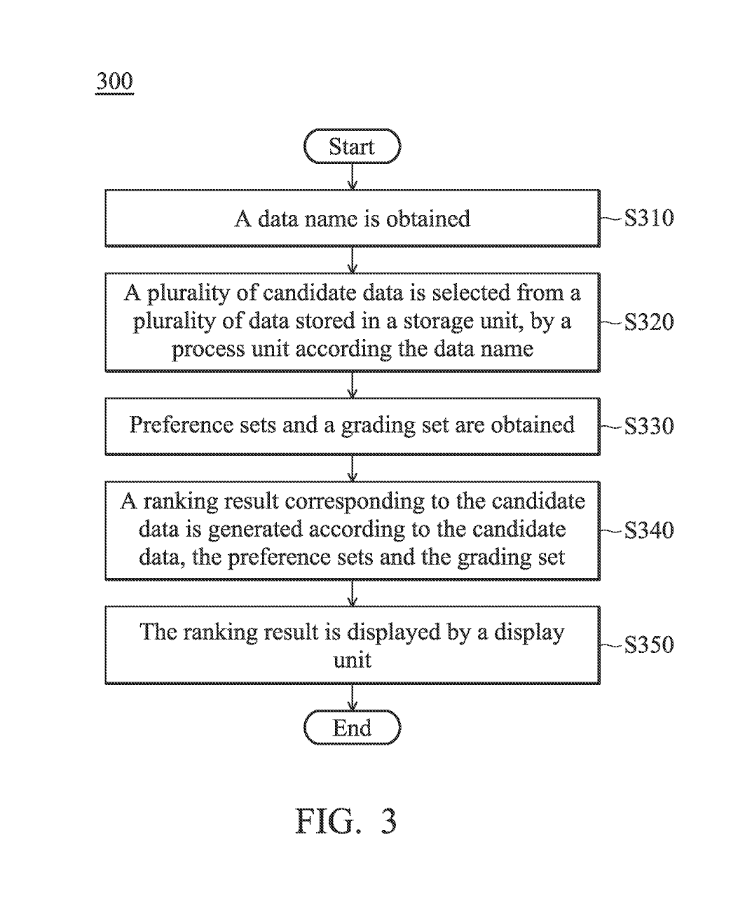

FIG. 3 is a flowchart of a data search method according to an embodiment of the invention. In step S310, a data name is obtained. In step S320, a plurality of candidate data is selected from a plurality of data stored in a storage unit, by a process unit according the data name. In step S330, preference sets and a grading set are obtained. In step S340, a ranking result corresponding to the candidate data is generated according to the candidate data, the preference sets and the grading set. In step S350, the ranking result is displayed by a display unit. In an embodiment of the invention, the method further comprises quantifying the parts of the selected preference sets which have not been quantified. In an embodiment of the invention, the process unit may transmit the ranking result to the storage unit, and update ranked information of the candidate data in the storage unit.

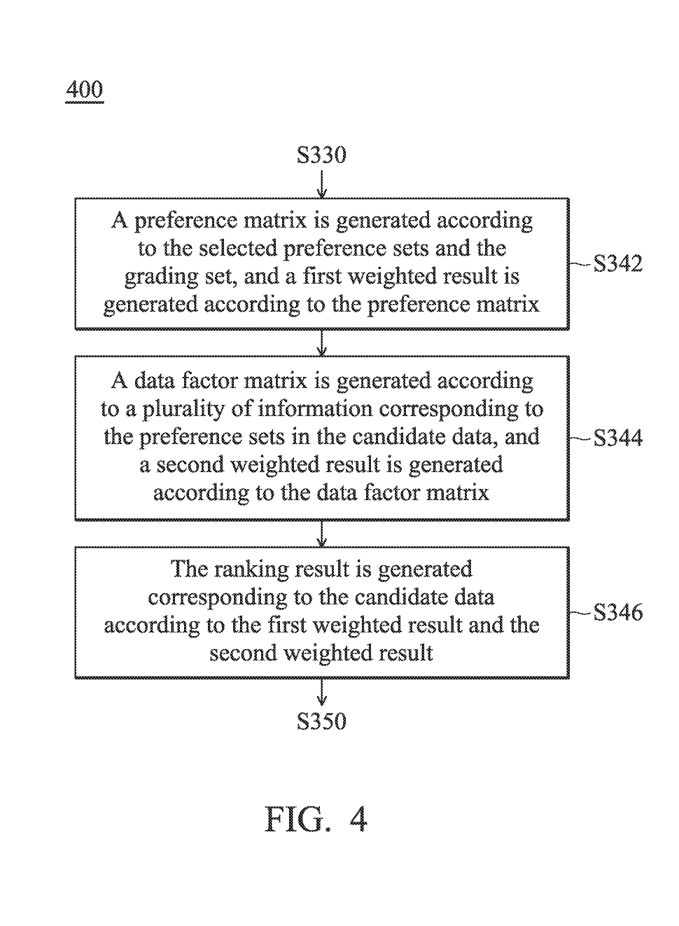

FIG. 4 is a flowchart of the step S340 of FIG. 3 according to an embodiment of the invention. In an embodiment of the invention, the step S340 comprises the step S342, step S344 and step S346. In step S342, a preference matrix is generated according to the selected preference sets and the grading set, and a first weighted result is generated according to the preference matrix. In step S344, a data factor matrix is generated according to a plurality of information corresponding to the preference sets in the candidate data, and a second weighted result is generated according to the data factor matrix. In step S346, the ranking result is generated corresponding to the candidate data according to the first weighted result and the second weighted result.

The data search method in the invention can provide different preference search results for different users. For example, research and development (RD) personal, quality assurance engineers and procurement engineers can search for devices according to their preference. In addition, the data search method in the invention can provide preference search results for different customers. Therefore, the data search method in the invention provides a more convenient and reliable method of data search, and users may select the most appropriate device according to their preferences.

The above paragraphs describe many aspects of the invention. The teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data search apparatus, comprising:
a storage unit, storing a plurality of data;
an input unit, inputting a data name, selecting a plurality of preference sets and inputting a grading set, by a user;
a process unit, receiving the data name for searching for a plurality of candidate data from the data stored in a storage unit and generating a ranking result according to the candidate data, the preference sets and the grading set; and
a display unit, displaying the ranking result.

2. The apparatus of claim 1, wherein the process unit comprises:
a search module, searching the candidate data from the storage unit;
a quantification module, quantifying parts of the preference sets which were not quantified; and
a measuring module, generating the ranking result corresponding to the preference sets according to the candidate data, the preference sets and the grading set.

3. The apparatus of claim 2, wherein the measuring module generates a preference matrix according to the preference sets and the grading set, and generates a first weighted result according to the preference matrix.

4. The apparatus of claim 3, wherein the measuring module generates a data factor matrix according to a plurality of information corresponding to the preference sets in the candidate data, and generates a second weighted result according to the data factor matrix.

5. The apparatus of claim 4, wherein the measuring module generates the ranking result corresponding to the candidate data according to the first weighted result and the second weighted result.

6. The apparatus of claim 1, wherein the process unit may transmit the ranking result to the storage unit, and update ranked information of the candidate data in the storage unit.

7. The apparatus of claim 6, wherein the preference sets comprise a preference rank corresponding to the different types of users and the process unit updates the preference rank according to the ranked information.

8. A method for data search, comprising:
obtaining a data name;
searching a plurality of candidate data from a plurality of data stored in a storage unit by a process unit according to the data name;
obtaining preference sets and a grading set;
generating a ranking result according to the candidate data, the preference sets and the grading set; and
displaying the ranking result by a display unit.

9. The method of claim 8, further comprising:
quantifying parts of the preference sets which were not quantified.

10. The method of claim 9, further comprising:
generating a preference matrix according to the preference sets and the grading set, and generating a first weighted result according to the preference matrix;
generating a data factor matrix according to a plurality of information corresponding to the preference sets in the candidate data, and generating a second weighted result according to the data factor matrix; and
generating the ranking result corresponding to the candidate data according to the first weighted result and the second weighted result.

11. The method of claim 8, wherein the process unit may transmit the ranking result to the storage unit, and update ranked information of the candidate data in the storage unit.

12. The method of claim 11, wherein the preference sets comprise a preference rank corresponding to the different types of users and the process unit updates the preference rank according to the ranked information.
